(19) United States
(12) Patent Application Publication
(10) Pub. No.: US 2009/0017736 A1
(43) Pub. Date: Jan. 15, 2009

(54) SINGLE-USE EDGING WHEEL FOR FINISHING GLASS

(75) Inventors: Robert G. Block, Framingham, MA (US); Srinivasan Ramanath, Holden, MA (US); Daniel L. Schier, Glen Ellyn, IL (US)

Correspondence Address: HOUSTON ELISEEVA, 4 MILITIA DRIVE, SUITE 4, LEXINGTON, MA, 02421, US

(73) Assignee: Saint-Gobain Abrasives, Inc., Worcester, MA (US)

(21) Appl. No.: 11/775,269

(22) Filed: Jul. 10, 2007

(51) Int. Cl. B24D 3/02; C09K 3/14

(52) U.S. Cl. 451/260; 51/309

(57) ABSTRACT

A single-use grinding tool includes a wheel portion having a profiled recess (e.g., such as a U, V, or bowl shape) extending circumferentially along the wheel portion's periphery. A multi-layered bonded abrasive (e.g., 3-dimensional matrix of abrasive grains and bond material, or multiple layers of abrasive tape) is conformably coated or otherwise applied in a uniform thickness along the profiled recess. The bonded abrasive in one particular case includes a metal bond with diamonds. However, organic, resinous, vitrified, and hybrid bonds, as well as other abrasive grit types, can be used. The wheel portion is supported by an arbor portion which may be removably coupled to the wheel portion, or formed integrally with the wheel portion. The tool is useful, for example, in edge grinding a workpiece, such as sheet glass. Methods of tool use and tool manufacture are disclosed as well.

### BACKGROUND

1. Field of the Invention

The present invention relates generally to grinding tools and more particularly to grinding tools for use in edge grinding and/or finishing.

2. Background Information

The use of diamond-containing abrasive wheels to contour and/or chamfer the edge of flat glass (also referred to herein as sheet glass), such as that used in the automotive, architectural, furniture, and appliance industries, is well known and is typically carried out for both safety and cosmetic reasons. The abrasive wheels of the prior art include a profiled, bonded abrasive matrix disposed in a recess at the periphery of the wheel (see, for example, U.S. Pat. Nos. 3,830,020, 4,457,113, and 6,769,964 each of which is incorporated by reference in its entirety).

Current diamond flat glass edging wheels require retruing or reprofiling of their forms in order to fully utilize diamond depths provided by either hot pressed or cold pressed and sintered powered metal compacts. This reprofiling of the form of the diamond section can occur up to 8 times in the life of the diamond wheel, with incumbent additional costs. The forms of such conventional edging wheels generally fall into one of three categories: pencil edging, seaming, and ogee-type. Other more complex shaped edges, such as the “triple waterfall” or “triple-ogee” are also made, primarily for glass tabletops.

There are a number of unresolved issues associated with reprofiling edge grinding tools.

### SUMMARY

One embodiment of the present invention provides a single-use grinding tool for shaping an edge of a glass sheet. The tool includes a wheel configured for engagement with an arbor (the wheel having an axis of rotation), and a profiled recess that extends along a periphery of the wheel, the profiled recess having a profile corresponding to a desired edge profile (e.g., U-shaped, V-shaped, or basket-shaped) of the glass sheet. A multi-layered bonded abrasive is disposed in the profiled recess, and is conformably disposed at a substantially uniform thickness along the predetermined profile, thereby providing the multi-layered bonded abrasive with an abrasive profile configured to impart the desired edge profile to the glass sheet upon rotation of the tool about the axis. The multi-layered bonded abrasive may be, for example, free-sintered. Alternatively, the multi-layered bonded abrasive may be hot-pressed or hot-coined in a split mold. The wheel can be removably coupled to the arbor (which may or may not be included with the tool). In one particular embodiment, the wheel and the arbor are of unitary construction. The wheel can be fabricated, for example, from materials such as aluminum alloys, magnesium alloys, and iron alloys. Alternatively, the wheel could be non-metallic (e.g., composite or polymer), or at least a portion thereof. Hybrid wheels including multiple materials may also be used (e.g., including both metallic and non-metallic portions). In one particular embodiment, the bonded abrasive includes a superabrasive grain disposed within a matrix. In one such case, the superabrasive grain comprises a particle size distribution ranging from: greater than or equal to about 2 microns, and less than or equal to about 300 microns. In another such case, the superabrasive grain comprises a particle size distribution ranging from: greater than or equal to about 20 microns, and less than or equal to about 200 microns. The matrix may be, for example, greater than or equal to about 5 volume percent superabrasive grain, and less than or equal to about 25 volume percent superabrasive grain. The matrix may include metallic, organic, resinous, and/or vitrified bonds. In one particular case, the matrix is a metal bond matrix that includes diamond. The metal bond may include, for example, bronze, copper, zinc, cobalt, iron, nickel, silver, tin, aluminum, indium, phosphorous, antimony, titanium, tungsten, zirconium, chromium, hafnium, and hydrides, alloys, and mixtures thereof. In one particular such case, the metal bond comprises a bronze alloy and a material selected from the group consisting of cobalt, iron, tungsten, and mixtures and alloys thereof. Alternatively, the metal bond includes a nickel-chrome alloy. In one particular such case, the metal bond comprises a nickel-chrome alloy and a material selected from the group consisting of cobalt, iron, tungsten, and mixtures and alloys thereof The wheel may have a diameter, for example, ranging from greater than or equal to about 75 millimeters, and less than or equal to about 300 millimeters.

Another embodiment of the present invention provides a method for shaping an edge of a glass sheet. The method includes mounting on a grinding machine, a single-use grinding tool. The single-use grinding tool includes a wheel configured for engagement with an arbor (the wheel having an axis of rotation), and a profiled recess that extends along a periphery of the wheel, the profiled recess having a profile corresponding to a desired edge profile of the glass sheet. A multi-layered bonded abrasive is disposed in the profiled recess, and conformably disposed at a substantially uniform thickness along the predetermined profile, thereby providing the multi-layered bonded abrasive with an abrasive profile configured to impart the desired edge profile to the glass sheet upon rotation of the tool about the axis. The method continues with applying the edge of the glass sheet to the multi-layered bonded abrasive as the single-use grinding tool rotates on the grinding machine about the axis. In one such embodiment, the method continues with discarding the grinding tool once the abrasive profile falls beyond dimensional specifications (e.g., such as edge roundedness, edge pointedness, and/or edge finish) associated with the desired edge profile.

Another embodiment of the present invention provides a method for fabricating a single-use edging tool for finishing glass. The method includes providing a wheel having an axis of rotation, and a recess extending along a periphery of the wheel, the recess having a profile corresponding to a desired profile of a glass workpiece. The method continues with conformably disposing a multi-layered paste and/or tape of abrasive and bond along the profile, and applying heat and/or pressure to the paste/tape to form a multi-layered bonded abrasive having an abrasive profile configured to impart the desired edge profile to the glass workpiece upon rotation of the tool about the axis. Prior to applying heat and/or pressure, the method may further include applying a template to the paste/tape to provide the paste with a substantially uniform thickness along the profile. Applying heat and/or pressure may include, for example free-sintering the paste/tape. Alternatively, applying heat and/or pressure may include hot-pressing or hot-coining to the paste/tape in a split mold.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a schematic representation of a prior art grinding wheel;

FIG. 1B is a schematic representation of a prior art grinding wheel;

FIG. 2A is a cross sectional representation of a grinding tool according to one embodiment of the present invention;

FIG. 2B is a cross sectional representation, on an enlarged scale, of a portion of the grinding tool of FIG. 2A;

FIG. 3A is a view similar to that of FIG. 2B, of another embodiment of a grinding tool of this invention; and

FIG. 3B is a view similar to that of FIGS. 2B and 3A, of still another embodiment of a grinding tool of this invention.

### DETAILED DESCRIPTION

Embodiments of the present invention include grinding tools and related techniques useful in edge grinding a workpiece, such as sheet glass for use in various applications including automotive windows, architectural or ornamentation, furniture, and appliances.

### General Overview

Grinding tools configured in accordance with an embodiment of the present invention address various unresolved issues associated with reprofiling edge grinding tools, such as those associated with degradation in wheel performance due to changes caused by resulting process variations. In particular, reprofiled tools exhibit reduced surface speeds on machines with fixed motor revolutions per minute (RPMs). For instance, a 150 mm diameter wheel, reduced in diameter by 7 reprofilings that each take about 0.030″ radially, would rotate at 5028 surface feed per minute (sfm) verses the original 5412 sfm (a 7% reduction in wheel speed), thereby impairing the ability of the edging wheel to maintain both line speed and surface finish. In addition, coolant jackets are generally fixed, meaning that there will be some variation in the amount of coolant that reaches the grinding zone with each wheel reprofiled. Also, wheel set-up is made more difficult, since both the diameter of the wheel and the axial location of the form shift from reprofile to reprofile. Furthermore, there is a variation in the ability of individual glass processing plant or merchant reprofiling companies to meet the originally specified form of a tool.

Greater process control and lower maintenance costs can be achieved by the use of a single-use edging wheel, configured in accordance with principles of the present invention. In one particular embodiment, an edge reprofiling tool is provided with a minimum amount of abrasive required for grinding the equivalent of the first run of a wheel, which is typically 100,000 to 300,000 linear inches for 4 mm thick glass, prior to the first reprofile. A conformal abrasive layer, sufficiently thick for such a first run, is supported on a core having appropriate face geometry. The core can be, for example, made of steel or other suitable material (e.g., aluminum or non-metallic composite), and imparts its preformed perimeter shape (e.g., such as a U, V, or bowl shape) to the abrasive face geometry of the edging tool, which in turn imparts that shape to the edge of the work piece. When using a low melting point core material such as aluminum, the abrasive section of the edging wheel may be made, for example, as a ring on a steel core (or other suitable material that can withstand high processing temperatures). The abrasive ring can then subsequently be attached to an aluminum or other low melting point core (e.g., using epoxy or brazing). Alternatively, a low temperature metal bond (e.g., braze composition or other suitable low temperature bond) for holding the abrasive grit (e.g., superabrasive such as diamond) can be used, where the metal bond is processable at temperatures below the melting point of aluminum. The same holds true for other low melting point core materials (e.g., polymer cores).

In any case, the supported conformal abrasive layer can be, for instance, usable as is on an edging machine (e.g., wheel having unitary construction that includes the conformal abrasive layer on a preformed perimeter of the wheel). Alternatively, the supported conformal abrasive layer can be incorporated as a ring into an injection molded die cast or sandwiched or otherwise integrated into a wheel assembly (e.g., metal ring that includes the conformal abrasive layer on a preformed perimeter of the ring, and is incorporated into an injection molded die cast of a lightweight aluminum wheel body construction).

In one example embodiment of the present invention, a single-use grinding tool includes a wheel portion having a profiled recess (e.g., such as a U, V, or bowl shape) extending circumferentially along the wheel portion's periphery. A multi-layered bonded abrasive (e.g., 3-dimensional matrix of abrasive grains and bond material, or multiple layers of abrasive tape) is conformably coated or otherwise applied in a uniform thickness along the profiled recess. The wheel portion is supported by an arbor portion which may be removably coupled to the wheel portion, or formed integrally with the wheel portion. The arbor portion includes a threaded end or other suitable means for coupling to a conventional grinding machine. Note that the term “single-use” as used herein is intended to describe the use period that extends up to the point-in-time in an edge grinding tool's life when reprofiling would be needed. Further note that this use period may occur over multiple grinding sessions, as opposed to a single grinding session.

Various embodiments of the present invention advantageously provide a relatively inexpensive tool that may be economically used to edge grind sheet glass, and then discarded or recycled after a single use. In addition, problems associated with reprofiled tools, such as reduced surface speeds on machines with fixed RPMs, inconsistent coolant delivery from fixed coolant guards, and relatively difficult wheel set-ups necessitated by shifts in both wheel diameter and the axial location of the tool's form, can be avoided.

As used herein the term arbor refers to a device that couples to the spindle or axle of a grinding machine, and to which a tool such as a cutting, grinding, or polishing wheel is mounted for imparting rotary motion as typically done. A unitary arbor refers to an arbor that is an integral part of the tool, such that a grinding wheel and arbor are of a unitary construction. The term edge grinding refers to a grinding operation in which a workpiece, such as sheet glass, is shaped (e.g., polished, contoured and/or chamfered) by grinding an edge thereof.

### Wheel Construction

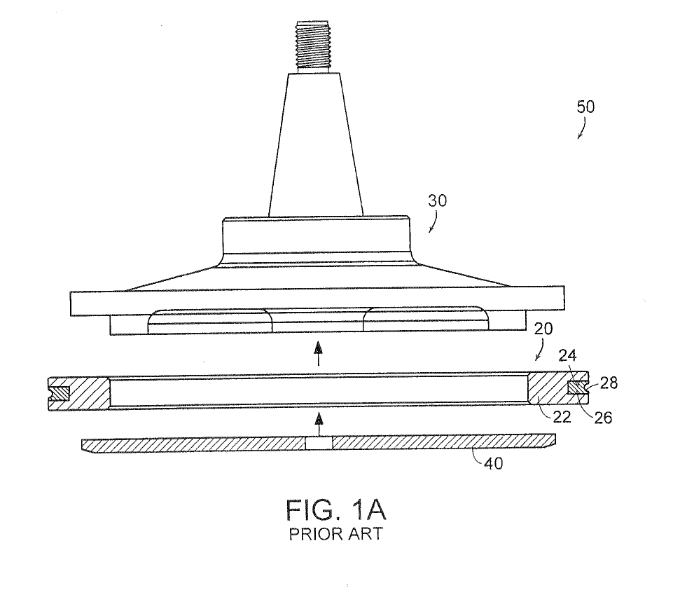

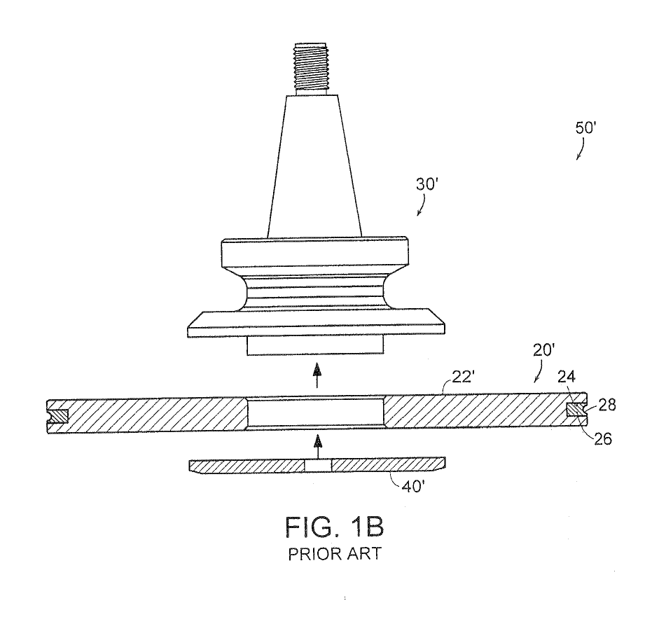

FIGS. 1A and 1B, illustrate examples of conventional grinding tools 50, 50′, which typically include a grinding wheel 20, 20′ mountable (e.g., by bolting) on an arbor 30, 30′. In general, the features demonstrated in FIGS. 1A and 1B can also be used in various embodiments of the present invention, as will be explained in turn. The grinding wheel 20, 20′ typically includes a bonded abrasive 26 disposed thereon. Grinding wheels 20, 20′ typically include a flat, annular body portion 22, 22′ the periphery of which is radially inwardly slotted (e.g., about the center plane) to provide an annular recess 24, which holds and acts as a support structure for the bonded abrasive 26. The bonded abrasive 26 includes a U or V shape profile 28 that is ground or otherwise manufactured therein, which is reproduced on the glass. Wheels of this configuration are commonly referred to as ‘pencil edging’ grinding wheels due to their profile 28. Grinding wheel 20, 20′ is typically mounted to arbor 30, 30′ through the use of flange 40, 40′, which serves to distribute operational stresses away from the central hole.

Grinding tool 50, 50′ is typically used to shape sheet glass such as that used in automobiles, furniture, architecture, and appliances. The grinding wheel 20, 20′ is dressed periodically (e.g., with an aluminum oxide abrasive stick) to re-expose the abrasive grains and remove any impacted glass fines from the surface of the wheel. When the profile 28 has worn sufficiently to be out of tolerance, or to produce edge chipping (edge chipping is often observed when the profile 28 becomes attenuated), the wheel is removed and reprofiled by, for example, form grinding with a silicon carbide wheel or by electro discharge machining (EDM). During reprofiling, the wheel 20, 20′ is typically removed from the arbor 30, 30′.

Note that conventional edge grinding tools are typically made using a steel ring and a core. The perimeter of the core is packed with abrasive-bond powder and the steel ring is placed on top. The excess steel is then machined away to expose the abrasive-bond layer. A geometric profile is then carved or otherwise machined (e.g., via grinding or EDM) into the abrasive-bond layer. There is also variation in bond mechanical properties (such as hardness) in conventional edging wheels across the axial thickness of the wheel, due to die-wall and internal friction within the abrasive-bond layer. The grain structure is oriented in the axial direction.

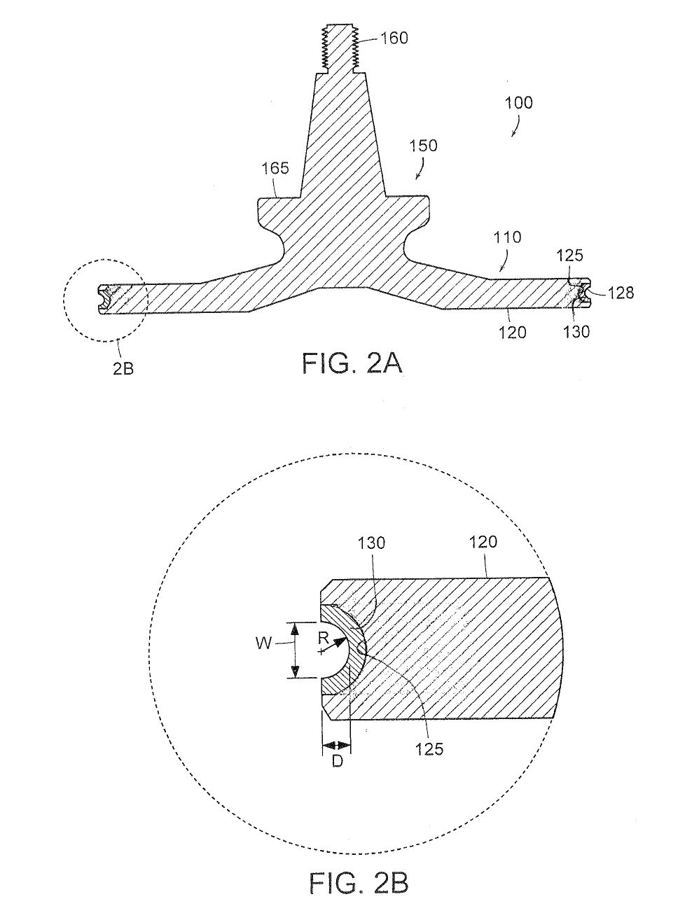

Embodiments of the present invention eliminate the need for carving a profile into the abrasive-bond layer, by using a wheel having pre-profiled recess to which the abrasive-bond layer conforms, as will be discussed with reference to FIGS. 2A-B and 3A-B. In addition, various embodiments of the present invention have more uniform properties because die-wall friction is eliminated and internal friction reduced via the use of liquid phase sintering. In one such particular case, the bond in which the abrasive is held is a nickel-chrome alloy configured with fillers that provide certain desired wear properties. The bond-abrasive ratio by volume, which is typically maintained at 62.5/37.5 maximum, can be further changed (higher concentration) so as to provide more porous products, such as that appropriate for a vitrified edge grinding wheel. In such an application, the bond-abrasive ratio by volume could be, for example, around 90/10. Conventional pore inducing techniques can be employed as desired (e.g., using sacrificial pore inducers that are burned out during processing, or using pore inducers that survive processing and remain in the finished tool, or using agglomerates of grain and bond that inhibit tight packing densities).

Moreover, wheels configured in accordance with embodiments of the present invention may be profiled under controlled factory conditions to help prevent irregularities introduced by less accurate operations in the field or otherwise associated with reprofiling processes. Such single-use wheels may be mechanically fastened to an arbor 30, 30′ (e.g., with a flange 40, 40′) as shown in FIGS. 1A, 1B. Alternatively, other embodiments may include integral arbors as will be discussed with reference to FIG. 2A. Such alternative embodiments may eliminate any eccentricities between the arbor and wheel to further reduce or eliminate transient edge chipping and other problems associated with a non-concentric coupling between the wheel and arbor. This alternative approach also eliminates the need to maintain a supply of relatively expensive multi-use arbors. As such, the various embodiments of the present invention may reduce both capital costs and operating expenses. For convenience, embodiments of the present invention will be shown and described with unitary arbors, with the understanding that the description thereof also applies to those embodiments using mechanically fastened arbors.

Referring now to FIG. 2A, a grinding tool configured in accordance with one embodiment of the present invention is illustrated. As can be seen, grinding tool 100 includes a wheel portion 110 having a body 120 with a profiled recess 125 extending along a periphery thereof. The integral profile of recess 125 corresponds to a desired edge profile of the glass sheet or other workpiece to be ground. A multi-layered bonded abrasive 130 is conformably disposed at a substantially uniform thickness along the profiled recess 125 (e.g., by free-sintering in-situ or other suitable methods as will be discussed in turn). Bonded abrasive 130 thus serves as abrasive means for the wheel portion 110, while profiled recess 125 serves as support means for the bonded abrasive 130.

This configuration allows for a multi-layered bonded abrasive 130 having an abrasive profile 128 (also referred to herein as a profiled grinding surface), which is sized and shaped to dimensional specifications predetermined to impart the desired profile to the edge of the glass sheet or other workpiece during operation. Moreover, the uniform thickness of the bonded abrasive 130 is predetermined to provide for a single-use, by providing sufficient thickness to substantially prevent the recess 125 from being exposed to the glass during grinding operation as long as abrasive profile 128 remains within the aforementioned dimensional specifications. In general, a single layer of bonded abrasive is inappropriate, in that such a layer would not provide sufficient interface to profiled recess 125 and may also be susceptible to gouge marks that expose the bare body 120 to the workpiece. This is not intuitive, as there are a number of single layer metal bond abrasive products that can be successfully used in other applications, such as rough grinding of metal workpieces. It will be appreciated in light of this disclosure that different grinding applications are each associated with a number of challenges that must be considered, with some of those challenges being difficult to even identify let alone resolve.

Once abrasive profile 128 is used to the point of being out of tolerance (or otherwise determined to be spent), wheel 100 is simply removed and discarded (e.g., recycled) and replaced with a new wheel 100. Use of body 120 having a pre-profiled recess 125, in combination with free-sintering technology to secure a multi-layered bonded abrasive 130, effectively enables the body itself to serve as a mold for the abrasive 130 and automatically imparting abrasive profile 128. This advantageously tends to lower manufacturing costs relative to conventional edge grinding wheels which generally rely on discrete molds and relatively complex machining operations to provide the requisite abrasive profile. In alternative embodiments, the multi-layered bonded abrasive 130 can be hot-pressed or hot-coined in a “split” mold (as opposed to free-sintered). A split mold can be used to remove the wheel from the mold, especially when the wheel has a form in it which prevents it being removed otherwise. Hot-pressing generally refers to the simultaneous application of heat and pressure to densify the product. Hot-pressing could be done, for example, in a steel mold if the temperature is below 450° C., and a graphite mold at higher temperatures (e.g., 450° C. to 1100° C.). In the case of hot-coining, the abrasive (e.g., diamond) containing bond powder fills a suitable mold (e.g., steel) which is then heated in a furnace (e.g., to between 500° C. and 750° C.). The mold with the abrasive bond powder is then removed while hot and densified in a press adjacent to the furnace. Assuming a steel mold, there is a limit on process temperature for hot-coining, since steel tends to soften above 750° C.

In addition, embodiments of the present invention that utilize a unitary arbor 150 and wheel 110 combination may further reduce manufacturing costs by eliminating the need to maintain close manufacturing tolerances therebetween. Such unitary construction offers enhanced structural integrity relative to discrete components mechanically fastened to one another. Thus, the unitary construction may enable the use of relatively inexpensive materials. Still further, since the tool 100 is designed for only a single-use, and does not need to withstand the fatigue associated with repeat usage, wheel portion 110 (and the unitary arbor 150, if so equipped) may be fabricated with less robust materials than may otherwise be required, including relatively inexpensive plastics or composites. In addition, note that the arbor 150 and wheel portions 110 may be fabricated using materials and/or construction techniques that enable them to be easily recycled, such as by inserting new bonded abrasive 130 into the profiled recess 125. Note, however, that alternative embodiments of the present invention can be fabricated with conventional assemblies and materials, and a unitary construction or particular materials are not required.

The profiled recess 125 (and accordingly, abrasive profile 128) is typically U, V or basket-shaped but may include substantially any shape, including those necessary to provide beveled, chamfered, ogee, flat, arris, and the like edge patterns on sheet glass. An abrasive profile 128 varies depending on the glass thickness being ground and may be defined by a width (W), depth (D), and radius of curvature (R), as shown in FIG. 2B. One standard profile that tends to provide a relatively long life and satisfactory edge quality is defined as follows: W=2\sqrt{D(2R−D)}, where width (W) equals the workpiece (e.g., glass) thickness plus 0.5 millimeters and the minimum radius of curvature (R) is approximately equal to the glass thickness divided by two.

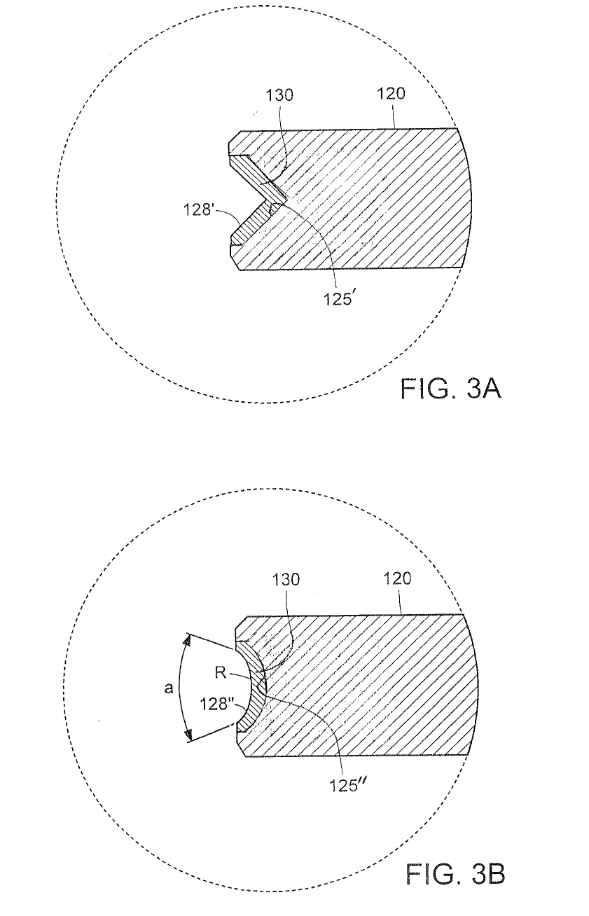

For many applications, a better surface finish may be achieved using a basket profile: W/2=RCos(a/2)−(R−D)Tan(a/2), wherein a is the included angle (between the frusto-conical edges of the basket) and ranges from about 50 to about 60 degrees, and R is the radius of curvature of the bottom of the basket. V-shaped 128′ and basket-shaped 128″ abrasive profiles are shown in FIGS. 3A and 3B, respectively. Once the desired geometries of abrasive profiles 128, 128′, 128″ are determined, the geometries of profiled recesses 125, 125′, 125″ can then be determined so as to accommodate those abrasive profiles 128, 128′, 128″ as well as a predetermined thickness of abrasive 130 therein.

As previously mentioned, and as shown in the embodiment of FIG. 2A, single-use grinding tool 100 includes an arbor portion 150 integral with the wheel portion 110 and body 120. Accordingly, arbor portion 150 functions as arbor means for imparting rotary motion from a grinding machine to the wheel portion 110. Arbor portion 150 may include a threaded end 160 or other suitable means for coupling to a grinding machine. The arbor portion 150 and wheel portion 110 may be fabricated from substantially any material (e.g., an iron alloy such as tool steel, or a relatively lightweight material such as aluminum alloys and magnesium alloys, or a non-metallic composite of suitable strength for the given application, or a combination). A relatively lightweight tool may advantageously reduce power consumption during use and result in less wear on drive spindles and other grinding machine components. A lightweight tool also tends to be relatively easy to mount and dismount from the grinding machine. In addition, note that a grinding tool including an aluminum body with a hardened steel insert at the mating face between the grinding tool and the grinding machine may also be desirable in that it provides for a light-weight grinding tool having a highly wear resistant arbor portion 150.

Grinding tool 100 may be substantially any size depending on the size and shape of the glass being ground. For typical applications, grinding tool 100 includes a wheel portion 110 having a diameter ranging from about 75 to about 300 millimeters (e.g., 254 or 256 millimeters wheels).

The bonded abrasive 130 may include substantially any abrasive grain material. Example abrasives include alumina, cerium oxide, silica, silicon carbide, zirconia-alumina, garnet, and emery in grit sizes ranging from about 0.5 to about 5000 microns, with some particular embodiments having grit sizes ranging from about 2 to about 300 microns, and other particular embodiments having grit sizes ranging from about 20 to about 200 microns. Superabrasive grains including diamond and cubic boron nitride (CBN), having similar grit sizes, may also be used. Combinations of superabrasives and regular abrasives may also be employed, if so desired. For most glass shaping applications, diamond grain is typical but not required. Edge quality tends to be determined by the diamond grain particle size. Increasing diamond grain particle size tends to increase grinding speed and wheel life at the expense of edge quality, while decreasing diamond grain size tends to improve edge quality at the expense of grinding speed and wheel life. A superabrasive that can be used for pencil edging automotive glass, in accordance with one embodiment of the present invention, includes a particle size distribution ranging from about 74 to about 88 microns (e.g., finer than U.S. Mesh (Standard Sieve) 170 and coarser than U.S. Mesh 200). For chamfering, an example superabrasive includes a particle size distribution ranging from about 63 to about 74 microns (e.g., finer than U.S. Mesh 200 and coarser than U.S. Mesh 230). Architectural glass typically requires a finer finish than automotive glass and may be ground with multiple tools, such as a coarse tool having a superabrasive particle size ranging from about 125 to about 149 microns (e.g., finer than U.S. Mesh 100 and coarser than U.S. Mesh 120) followed by a fine tool having a superabrasive particle size ranging from about 63 to 76 microns (e.g., finer than U.S. Mesh 180 and coarser than U.S. Mesh 220). Superabrasive concentration within the bond matrix may vary relatively widely, but in accordance with one embodiment of the present invention is in the range from about 5 to about 13 volume percent for contouring applications and about 12 to about 25 volume percent for chamfering applications. Note that increasing superabrasive concentration tends to increase wheel life (as well as power consumption) and decrease grinding speed. Further note that although diamond is typically the superabrasive used in glass finishing applications, CBN may provide a suitable solution for edging thinner glasses, such as LCD sheets, where a gentler grinding action is acceptable (depending on factors such as desired stock removal rate and grain hardness). In addition, some types of glass may require CBN as the grit type. For example, glass ceramics containing high fluorine content should be ground with a CBN wheel, given the high affinity of diamond towards fluorine.

In one particular embodiment of the present invention, a nickel-chrome metal bond system is used in the bonded abrasive 130. Other example materials that can be used in a metal bond matrix include, but are not limited to, bronze, copper, and zinc alloys (e.g., brass), cobalt, iron, nickel, silver, tin, aluminum, indium, phosphorous, antimony, titanium, tungsten, zirconium, chromium, hafnium, and any hydrides, alloys, and combinations thereof Bronze alloys with low-level additions of cobalt, iron, and/or tungsten are generally desirable for most glass edging applications. Softer, less wear-resistant bonds may be used for furniture, architecture, or appliance glass and are generally made using relatively low levels of cobalt, iron, and/or tungsten. Increasing cobalt, iron, and/or tungsten at the expense of bronze tends to increase wear resistance. Automotive glass grinding applications may utilize highly wear resistant bonds having relatively high levels of cobalt, iron, and/or tungsten to provide long life, to minimize wheel changes on fully automated lines and hence reduce costly downtime. Note, however, that non-metallic bonds including organic, resinous, or vitrified bonds (together with appropriate curing agents if necessary) may also be used in the bonded abrasive 130, if so desired.

Consider, for example, a co-sintered monolithic wheel construction embodiment having a vitrified bond system, where the core (any preform for holding the bond/abrasive) is a vitrified center having comparable thermal expansion such that the single-use abrasive section would not crack during processing or a grinding session. Recall that ANSI B7.1-2000 requires that all wheels of such a construction be tested at 1.5 times operating speed. For a wheel with organic cement, a steel core can be used. Such a design can be qualified, for instance, for a standard speed of 16,000 surface feet per minute. In one such embodiment, a segmental construction is used to meet the various safety qualifications, as the hoop stresses for a circumferential ring may make passing those qualifications more difficult.

The particular choice of bond composition depends on the grinding application, and on the generally competing requirements of cost hardness (for durability) and the ability to flow during furnacing (sintering). Cost is a further factor (e.g., segmental designs may be more expensive than circumferential designs). In one particular embodiment, the bonded abrasive 130 is soft enough to flow during a free-sintering process to form a uniform bond with the pre-profiled recess 125, 125′, 125″ without cracking. In addition, the finished abrasive 130 should be sufficiently hard to provide a reasonable service life. For example, a bronze-based paste system applied to a steel wheel 110 may be used to provide the desired flowability with sufficient hardness for some applications. However, in the event the bronze-based system is considered to be too soft for particular applications, various additives may be added to increase hardness/durability for longer life. Example such additives include cast iron (e.g., 10 to 20 volume percent), DELCROME® Alloy No. 90 (white cast iron alloy available from Deloro Stellite Company, Inc., Goshen, Ind.), tungsten carbide, and/or other materials such as those discussed hereinabove. Alternatively, for applications in which particularly high hardness is desired, a nickel-chrome bond may be used, for example, in combination with a wheel 110 fabricated from stainless steel. This approach may provide relatively high levels of hardness while advantageously enabling the use of processing temperatures sufficiently low as to avoid excessively distorting the wheel 110 and arbor 150 portions during furnacing.

Embodiments of the present invention may be fabricated using conventional techniques. For example, the wheel and arbor portions 110, 150 may be fabricated as either unitary or discrete components as previously discussed from various materials, such as steel, stainless steel, or other metallic or non-metallic (e.g., composite) materials having sufficient structural integrity and capable of withstanding the associated manufacturing temperatures. These wheel/arbor portions may be fabricated using any desired fabrication method, such as machining, casting/molding, composite manufacture, and combinations thereof. In one particular embodiment, the abrasive is mixed with suitable bond (e.g., in the form of metal alloy powder) along with any desired binders and fillers, to form a paste. A uniform thickness of this paste is then coated or otherwise applied to pre-profiled recess 125, 125′, 125″. This uniform thickness may be provided, for example, by slowly rotating the wheel and scraping excess paste from the recess using a template formed as the inverse of the pre-profiled recess 125, 125′, 125″, thereby providing the desired abrasive profile 128, 128′, 128″. Alternatively, abrasive-bond tape may be applied in one or more layers to the pre-profiled recess 125, 125′, 125″ to provide the desired nominally uniform thickness of abrasive profile 128, 128′, 128″.

Once the paste or tape or other suitable abrasive 130 is applied to the pre-profiled recess 125, 125′, 125″, the wheel is free-sintered by placement within a furnace at sufficient temperature to burn off the binder, so that the metal alloy melts, flows, and encapsulates the abrasives and filler while bonding uniformly to the wheel. In one particular embodiment, the free-sintering is carried out in a protective atmosphere, such as in a vacuum or an atmosphere of argon, nitrogen, hydrogen or combinations thereof. Such a protective atmosphere is helpful, for example, in preventing oxidation of metal bonds. Oxidation generally leads to formation of an oxide layer on the surface of each bond particle, resulting in reduced sinterability and grit retention. Thus, depending on factors such as the bond composition's proclivity toward oxidation and the desired grit retention, free-sintering in a protective atmosphere may be appropriate. On the other hand, some bonds can be furnaced in either air or a protective atmosphere (e.g., vitrified bonds). The particular bond composition and process conditions may be controlled in a conventional manner to help ensure that shrinkage is uniform. The abrasive profile 128, 128′, 128″ may be touched-up with an abrasive implement (e.g., aluminum oxide abrasive stick or silicon carbide grinding wheel) or by machining (e.g., EDM) to help ensure the profile is within predetermined tolerances.

As previously discussed, the thickness of the abrasive 130 is predetermined to substantially prevent the abrasive 130 from being worn down to the wheel portion 110, or before the abrasive profile 128, 128′, 128″ becomes so attenuated as to be out of specification. Note that abrasive profile 128, 128′, 128″ may vary slightly within a range of tolerances capable of imparting an acceptable edge to a particular glass workpiece. During the normal course of edge grinding, abrasive grains will be gradually removed from recess 125, 125′, 125″, which will tend to attenuate the abrasive profile 128, 128′, 128″ until eventually the profile will be beyond the range of tolerances and thus out of specification. A single-use life expectancy can be based on an estimated total hours of use, which the end user may use as a guide in determining when to stop using the tool 100. The tool 100 may then be discarded and replaced with a new tool.

Use of the pre-profiled recess 125, 125′, 125″, in combination with the free-sintered abrasive 130, 130′, 130″, eliminates any need for the discrete molds and recess shaping processes commonly used to shape the relatively greater thicknesses of abrasive bond in the unprofiled recesses of conventional edging wheels such as shown in FIGS. 1A, 1B. This aspect itself, and optionally in combination with the use of unitary wheel/arbor 110, 150, provide for relatively simple and efficient manufacture, which in turn, effectively reduces costs sufficiently to enable fabrication of tool 100 as a single-use, disposable item.

The various grinding tool embodiments of the present invention may be used with substantially any conventional grinding machine, such as those provided by BYSTRONIC® Machinen Corporation (Switzerland), BANDO® Chemical Industries Corporation (Japan), and Glassline Corporation (Perrysburg, Ohio). During a typical grinding operation, glass is ground at rate ranging from about 2 to about 30 meters per minute. The abrasive profile 128 may be dressed periodically using an implement such as an aluminum oxide abrasive stick in order to maintain the grinding speed and edge quality.

The following illustrative examples demonstrate certain aspects and embodiments of the present invention, and are not intended to limit the present invention to any one particular embodiment or set of features.

### EXAMPLES

### Example 1

A single-use edging wheel was produced substantially as shown and described with respect to tool 100, using a one piece wheel/arbor portion 110, 150, in which the wheel 110 was fabricated from steel, and included a recess 125 substantially as shown and described with respect to FIG. 2B. The following bronze based paste system was used to provide the multi-layer bonded abrasive 130.
91 weight percent prealloyed bronze (77/23 Cu/Sn) −325 mesh;
9 weight percent titanium hydride;
10 volume percent micron diamond (3-5 micron, as a wear retardant);
40-50 volume percent water based binder (Vitta™ Binder) to form a paste with the proper consistency for application to the substrate; and
7-14 volume percent diamond in the 150-220 mesh range to serve as the working abrasive.
   In addition, 10 to 20 volume percent cast iron, DELCROME® 90 alloy, tungsten carbide, and/or other similar materials can be optionally added to the paste system to further increase durability/hardness.

### Example 2

A single-use edging wheel was produced substantially as shown and described with respect to tool 100 hereinabove, using a one piece wheel/arbor portion 110, 150, in which the wheel 110 was fabricated from 304 stainless steel, and included a recess 125 substantially as shown and described with respect to FIG. 2B. The following nickel-chrome based paste system was used.
Nicrobraze LM brazing alloy (Wall Colmonoy Corporation, Detroit, Mich.);
40-50 volume percent water based braze binder (Vitta Braz-Binder Gel™ from Vitta Corporation) to form a paste with the proper consistency for application to the substrate; and
7-14 volume percent diamond (150-220 mesh) to serve as the working abrasive.
   In addition, 10 to 20 volume percent cast iron, DELCROME® 90 alloy, stainless steel, and/or other similar material can be optionally added to the paste system to further increase durability/hardness, as will be appreciated in light of this disclosure.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A single-use grinding tool for shaping an edge of a glass sheet, the tool comprising:
a wheel configured for engagement with an arbor, the wheel having an axis of rotation;
a profiled recess extending along a periphery of the wheel, the profiled recess having a profile corresponding to a desired edge profile of the glass sheet; and
a multi-layered bonded abrasive disposed in the profiled recess, the multi-layered bonded abrasive being conformably disposed at a substantially uniform thickness along the predetermined profile, thereby providing the multi-layered bonded abrasive with an abrasive profile configured to impart the desired edge profile to the glass sheet upon rotation of the tool about the axis.

2. The grinding tool of claim 1 wherein the multi-layered bonded abrasive is free-sintered.

3. The grinding tool of claim 1 wherein the multi-layered bonded abrasive is hot-pressed or hot-coined in a split mold.

4. The grinding tool of claim 1 wherein the wheel is removably coupled to the arbor.

5. The grinding tool of claim 1 comprising the arbor.

6. The grinding tool of claim 5 wherein the wheel and the arbor are of unitary construction.

7. The grinding tool of claim 1 wherein the wheel is fabricated from a material selected from the group consisting of aluminum alloys, magnesium alloys, iron alloys, non-metallic composites, polymers, and combinations thereof

8. The grinding tool of claim 1 wherein the bonded abrasive comprises a superabrasive grain disposed within a matrix.

9. The grinding tool of claim 8 wherein the superabrasive grain comprises a particle size distribution ranging from:
greater than or equal to about 2 microns; and
less than or equal to about 300 microns.

10. The grinding tool of claim 8 wherein the superabrasive grain comprises a particle size distribution ranging from:
greater than or equal to about 20 microns; and
less than or equal to about 200 microns.

11. The grinding tool of claim 8 wherein the matrix comprises from:
greater than or equal to about 5 volume percent superabrasive grain; and
less than or equal to about 25 volume percent superabrasive grain.

12. The grinding tool of claim 8 wherein the matrix comprises a bond selected from the group consisting of metallic, organic, resinous, and vitrified bonds.

13. The grinding tool of claim 8 wherein the matrix is a metal bond matrix.

14. The grinding tool of claim 13 wherein the superabrasive grain comprises diamond.

15. The grinding tool of claim 13 wherein the metal bond is selected from the group consisting of bronze, copper, zinc, cobalt, iron, nickel, silver, tin, aluminum, indium, phosphorous, antimony, titanium, tungsten, zirconium, chromium, hafnium, and hydrides, alloys, and mixtures thereof.

16. The grinding tool of claim 13 wherein the metal bond comprises a bronze alloy.

17. The grinding tool of claim 13 wherein the metal bond comprises a bronze alloy and a material selected from the group consisting of cobalt, iron, tungsten, and mixtures and alloys thereof.

18. The grinding tool of claim 13 wherein the metal bond comprises a nickel-chrome alloy.

19. The grinding tool of claim 18 wherein the metal bond comprises a nickel-chrome alloy and a material selected from the group consisting of cobalt, iron, tungsten, and mixtures and alloys thereof.

20. The grinding tool of claim 1 wherein the desired edge profile comprises a shape selected from the group consisting of U-shaped, V-shaped, and basket-shaped.

21. The grinding tool of claim 1 wherein the wheel comprises a diameter ranging from:
greater than or equal to about 75 millimeters; and
less than or equal to about 300 millimeters.

21. A method for shaping an edge of a glass sheet, the method comprising:
mounting on a grinding machine, a single-use grinding tool including:
a wheel configured for engagement with an arbor, the wheel having an axis of rotation;
a profiled recess extending along a periphery of the wheel, the profiled recess having a profile corresponding to a desired edge profile of the glass sheet; and
a multi-layered bonded abrasive disposed in the profiled recess, the multi-layered bonded abrasive being conformably disposed at a substantially uniform thickness along the predetermined profile, thereby providing the multi-layered bonded abrasive with an abrasive profile configured to impart the desired edge profile to the glass sheet upon rotation of the tool about the axis;
applying the edge of the glass sheet to the multi-layered bonded abrasive as the single-use grinding tool rotates on the grinding machine about the axis.

22. The method of claim 21, further comprising:
discarding the grinding tool once the abrasive profile falls beyond dimensional specifications associated with the desired edge profile.

23. A method for fabricating a single-use edging tool for finishing glass, the method comprising:
providing a wheel having an axis of rotation and a recess extending along a periphery of the wheel, the recess having a profile corresponding to a desired profile of a glass workpiece;
conformably disposing at least one of a multi-layered paste and tape of abrasive and bond along the profile; and
applying at least one of heat and pressure to the at least one of paste and tape to form a multi-layered bonded abrasive having an abrasive profile configured to impart the desired edge profile to the glass workpiece upon rotation of the tool about the axis.

24. The method of claim 23 wherein prior to applying at least one of heat and pressure, the method further comprises:
applying a template to the at least one of paste and tape to provide the at least one of paste and tape with a substantially uniform thickness along the profile.

25. The method of claim 23 wherein applying at least one of heat and pressure comprises free-sintering the at least one of paste and tape.

26. The method of claim 23 wherein applying at least one of heat and pressure comprises one of hot-pressing or hot-coining to the at least one of paste and tape in a split mold.
